(19) United States
(12) Patent Application Publication
(10) Pub. No.: US 2011/0308216 A1
(43) Pub. Date: Dec. 22, 2011

(54) Windeck Lawn Mower Blower Attachment Device

(76) Inventors: Steve Norton, Kalamazoo, MI (US); Brian Morga, Paw Paw, MI (US); Carl Orosz, Kalamazoo, MI (US); Devon Jackson, Kalamazoo, MI (US)

(21) Appl. No.: 13/159,608

(22) Filed: Jun. 14, 2011

Related U.S. Application Data
(60) Provisional application No. 61/356,594, filed on Jun. 19, 2010.

(51) Int. Cl. A01D 87/10

(52) U.S. Cl. 56/13.4

(57) ABSTRACT

An apparatus for creating a strong force of concentrated energy and a blowing force of air pressure in cooperation with an industrial, commercial or home care lawn mower. This device is a new combination of existing materials configured with unique features that provide an effective, practical and economical way to provide an air blower device. It is comprised of a main deck with features with one or more air ducts, a series of baffles to direct the air movement through the deck, and an exhaust duct; of at least one blower fan; and of a means to secure the main deck and blowers to a mower device.

### CROSS-REFERENCE TO RELATED APPLICATIONS

This application claims the benefit of Provisional Patent Application Ser. No. 61/356,594 filed Jun. 19, 2010 by Stephen Norton et al and entitled “Windeck Lawn Mower Blower Attachment Device”.

### FIELD OF INVENTION

This invention relates to an apparatus for creating a strong force of concentrated energy and more particularly, but not by way of limitation, an apparatus for creating a blowing force of air pressure in cooperation with an industrial, commercial or home care lawn mower. Particularly this new device is related to devices and methods to create and provide a strong force of air in a safe and efficient manner when used with a mower device or equal. This Windeck Lawn Mower Blower Attachment Device is a new combination of existing materials configured with unique features that provide an effective, practical and economical way to provide an air blower device. The preferred and alternative embodiments are described below.

### FEDERALLY SPONSORED RESEARCH

None.

### SEQUENCE LISTING OR PROGRAM

None.

### BACKGROUND-FIELD OF INVENTION AND PRIOR ART

### A. Introduction of the Problems Addressed

The use of air being blown to create a strong force which can move materials is desirable for many applications—debris and trash; lawn clippings and leaves; snow; etc. Often one finds people needing to harness and provide such an air blowing force resort to using and procuring a special piece of equipment to accomplish that need. What is addressed and solved by this Windeck Lawn Mower Blower Attachment Device is a means to quickly and easily adapt an existing mower of various sizes to harness and to provide a strong air blower. The device and scope of the invention shows that existing equipment combined with this Windeck device solves the need for a manner and means to harness exhaust air from a mower and direct it for the operators use in many desired applications. As far as known, there is no other mower blower attachment or related devices at the present time which fully provide these improvements and functional characteristics as the present Windeck Lawn Mower Blower Attachment Device. It is believed that this device is made with fewer parts with improved configurations and physical features to provide more functionality when compared to other currently utilized air blowing devices or auxiliary equipment aids.

The particular combinations of materials and features are unique and novel and are not anticipated by prior art. Likewise, use of a Windeck Lawn Mower Blower Attachment Device provides significant benefits compared to prior art devices.

### B. Prior Art

In prior art, disclosures have been made—many including large, complex devices and systems created to sweep or cause air to move materials such as grass, snow and debris. These are not only more costly to manufacture but lack the efficiency and ease of attaching the device(s) to the mowers demonstrated by the Windeck.

A motor lawn mower and sweeper was first taught by Coldwell in U.S. Pat. No. 796,811 issued in 1905. It shows a combination unit of cutting blades that are propelled and a mechanical sweeper. There is no teaching of the exhaust or auxiliary air movement used for any purpose. Another device by Thoen et al in U.S. Pat. No. 3,690,047, issued in 1972, shows a utility device that is a combination lawn mower and snow thrower. It teaches a combination lawn mower and snow blower wherein a rotary impeller member has a series of spaced disks axially mounted in spaced parallelism along a shaft with the disks being disposed at a substantially 45 degree angle to the shaft axis. The beater bars will cut through snow or grass and the disks will move the material rear-wardly under the shaft for upward ejection through a beater housing. The dual function machine is an integrated design and does not adapt to the various types of mower decks as the new Windeck demonstrates.

A garden grooming machine and rotor is taught in the U.S. Pat. No. 3,783,592 issued to Schraut in 1974. Here a self-propelled lawn vacuum, mower and sweeper having interchangeable reel-type mower and rotary brush units, both are feeding material tangentially toward the intake of the vacuum. The drive wheels are spring-loaded to follow the ground contour, and the height of the interchangeable units with respect to the vacuum is adjustable. A moveable shutter is interposed between the mower and brush units and the vacuum intake to regulate air flow. The device is integrated into the full mower and not adaptable across various deck types and sizes as is the Windeck.

A fully integrated, two-wheeled device is taught by Spinner as shown in U.S. Pat. No. 4,064,679 issued in 1977. This is a multi-use lawn care machine which can be used as a lawn mower, lawn sweeper or snow blower. The machine has a generally cylindrical housing to hold the tool (a snow blower reel, lawn mower reel, or lawn sweeper attachment) in use. One side plate of the housing is laterally removable, permitting access to and disconnection of the tool. A front wheel is mounted on the removable side plate. A front cover is removably attached to close the front of the housing when the machine is used as a lawn mower or lawn sweeper. The device is very complicated with many more moving and static parts than the Windeck. Another device is demonstrated in U.S. Pat. No. 4,996,829 issued in 1991 to Saitoh et al. It is a much more complex device than the simple Windeck. The lawn mower with blower is described as a riding lawn mower comprised of a frame supported by wheels, a mower housing carried at the underside of the frame, a plurality of cutter blades located within the mower housing to cut grass, a collection bag mounted on the rear of the frame, a discharge chute extending between the mower housing and the collection bag and defining a clipping path from the cutter blades into the collection bag, a blower including an impeller housing attached to the mower housing and an impeller located within the impeller housing and cooperating with the butter blades to convey the grass clippings into the collection bag through the discharge chute. Further, a short conduit connects the impeller housing to the upstream end of the discharge chute to conduct an air generated by the impeller into the discharge chute. Finally, a central axis of the conduit is shown as offset downwardly from a central axis of the discharge chute.

A lawn mower with a blower unit was issued in 1991 to Samejima et al as a U.S. Pat. No. 5,018,344. Here is a lawn mower comprising a blade housing supported above the ground by wheels, and a blower case removably connected to one lateral side of the blade housing for blowing grass clippings toward a grass catcher disposed rearwardly of a vehicle body. The blade housing carries wheel support frames secured thereto and extending in a fore and aft direction of the vehicle body. A forward coupling and a rear coupling are secured to one of the wheel support frames for connecting the blower case to the blade housing. The device again, like the other prior art, is complicated and has more components than the Windeck invention shown herein. Another complex snow blower and lawn mower apparatus was issued as a U.S. Pat. No. 5,090,142 to Peters in 1992. Here is taught an attachment arranged for mounting to an associated lawnmower in an operative relationship to include a snow blower housing operative through a plurality of inter-related belts and pulleys to effect rotation of a plurality of impeller blades mounted within the snow blower housing. A drive pulley is mounted to a lower terminal end of the lawnmower motor output shaft to operatively effect the afore noted rotation of the impeller structure.

### SUMMARY OF THE INVENTION

A Windeck Lawn Mower Blower Attachment Device has been developed and designed to provide a unique combination that is specifically related to devices and methods to provide an improved device for producing or rather transforming energy of a mower or tractor to air pressure or wind energy from a blower or the like. The Windeck Lawn Mower Blower Attachment Device may be used to easily and safely blow leaves, grass, debris and snow from a lawn or surface. The benefits are delineated below.

The preferred embodiment of the Windeck Lawn Mower Blower Attachment Device is comprised of a removable main deck with various features such as an inlet air chamber; one or more air ducts; a series of baffles to direct the air movement through the device; and an exhaust duct all of which, including the features, are made of durable materials, and as a preferred embodiment at least one blower fan; and means to secure the main deck and blowers to a mower device. An alternative embodiment anticipates at least one blower and a means to connect the blower(s) to the mower but without the main deck to the air flow without the same force as the preferred with the main deck and features.

### OBJECTS AND ADVANTAGES

There are several objects and advantages of the Windeck Lawn Mower Blower Attachment Device. There are currently no known Windeck Lawn Mower Blower Attachment Device or other air power and blower devices that are effective at providing the objects of this invention.

The following TABLE A summarizes various advantages and objects of the Windeck Lawn Mower Blower Attachment Device. This list is exemplary and not limiting to the many advantages offered by this new device.

TABLE A
Various Benefits, Advantages and Objects
This device:

| ITEM | BENEFIT |
|---|---|
| 1. | Much stronger and more powerful than traditional air |
| | blower devices |
| 2. | Uses existing equipment (mowers) for base power and |
| | converts its exhaust to wind energy |
| 3. | May be used with existing mowers |
| 4. | Is quick to change-over from cutting or mulching to |
| | blowing. |
| 5. | May be manufactured in an inexpensive manner with |
| | existing processes and equipment. |
| 6. | May be both installed and removed quickly. |
| 7. | May be stored in a relatively small area. |
| 8. | Is adaptable to various sized mowers. |
| 9. | Is easy to package and transport |
| 10. | Can be sold and distributed retail, wholesale, or E- |
| | commerce internet sales from a website |
| 11. | May have various outer configurations to adapt to |
| | different marketing themes. |
| 12. | May be used during all seasons |
| 13. | May be manufactured from various durable materials |
| | such as metal - steel, steel alloys, aluminum, etc. |
| | or composites - plastics, reinforced plastics, etc. |

Noteworthy is that other advantages and additional features of the present Windeck Lawn Mower Blower Attachment Device will be more apparent from the accompanying drawings and from the full description of the device. For one skilled in the art of air blower devices especially for lawn care, it is readily understood that the features shown in the examples with this device is readily adapted for improvement to other types of mechanisms and devices for use as an air blowing device or accessory.

### DESCRIPTION OF THE DRAWINGS

### Figures

The accompanying drawings, which are incorporated in and constitute a part of this specification, illustrate a preferred and alternative embodiments for the Windeck Lawn Mower Blower Attachment Device. The drawings together with the summary description given above and a detailed description given below serve to explain the principles of the Windeck Lawn Mower Blower Attachment Device. It is understood, however, that the device is not limited to only the precise arrangements and instrumentalities shown.

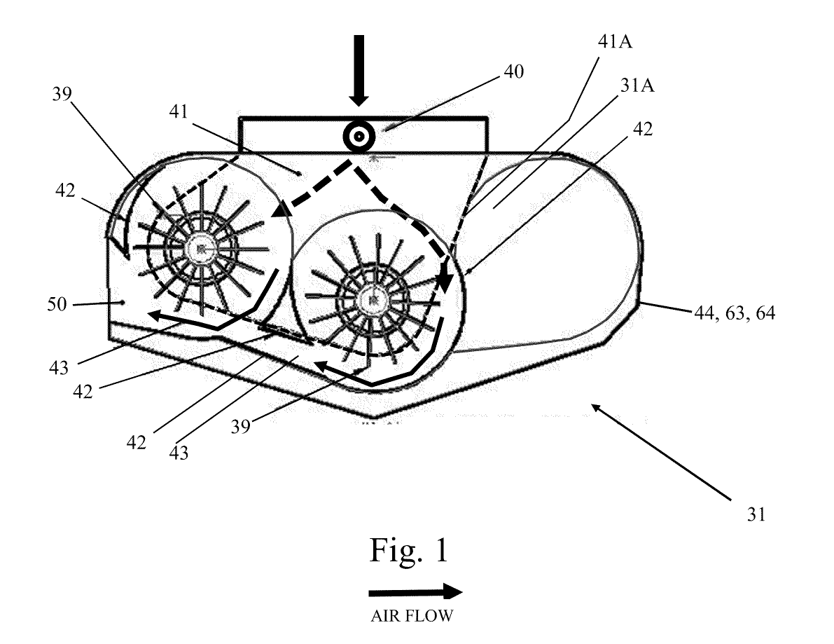

FIG. 1 is the general view of the Windeck Lawn Mower Blower Attachment Device with features and components identified.

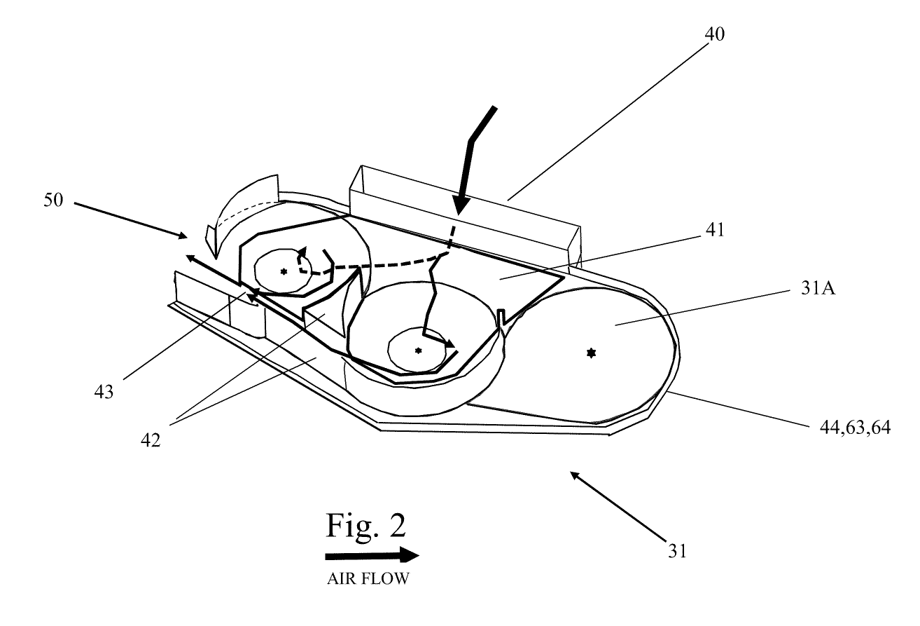

FIG. 2 is a Windeck housing without blower fans.

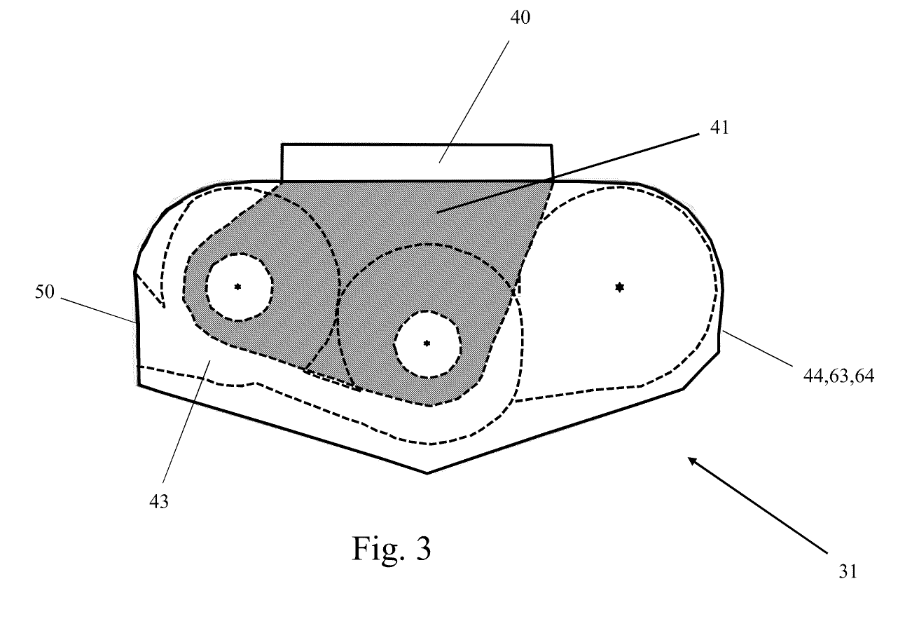

FIG. 3 is a Windeck top view without blower fans.

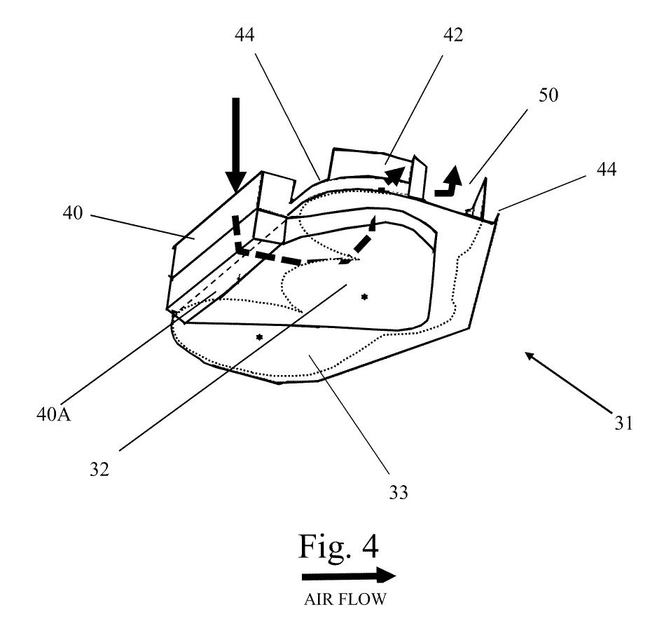

FIG. 4 is a Windeck with the general view of air ducts chamber underside.

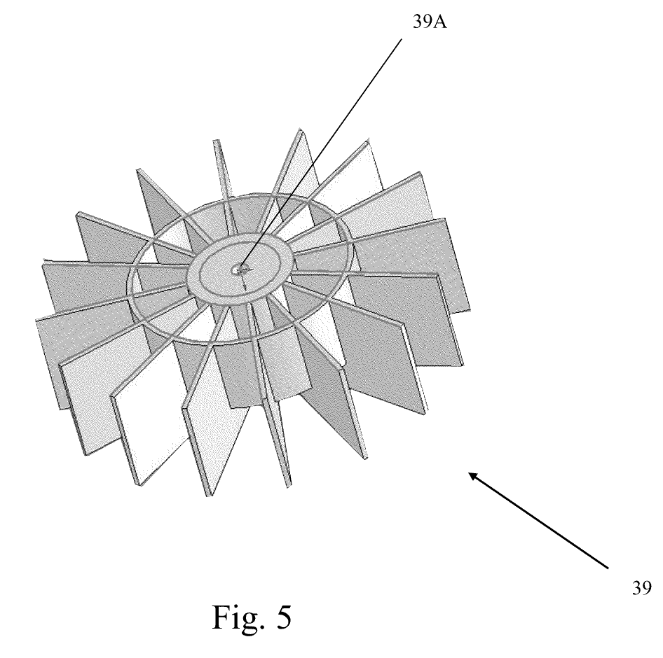

FIG. 5 is an isometric of a typical blower fan.

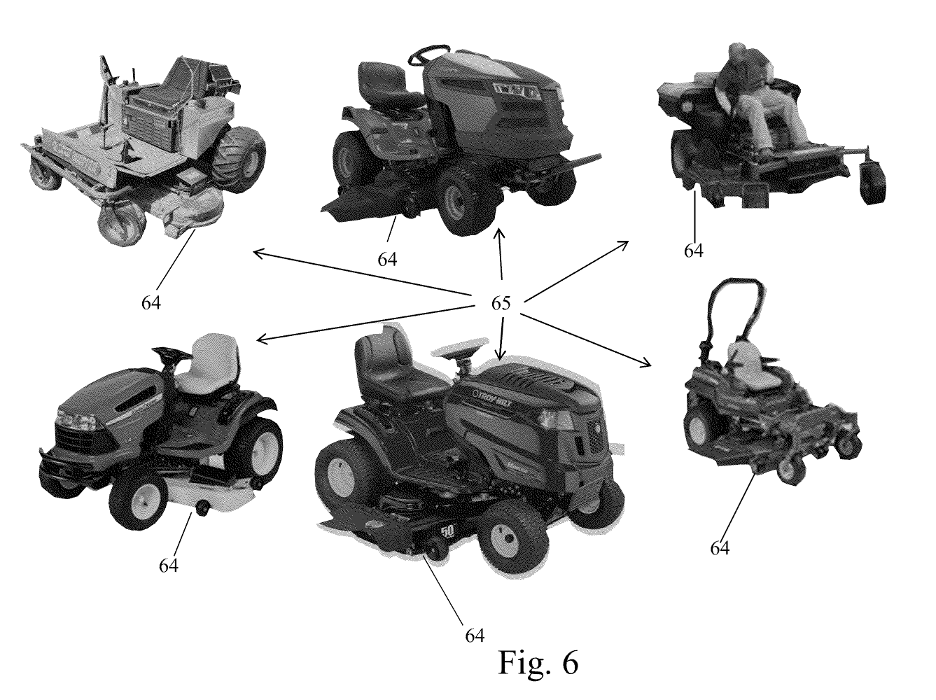

FIG. 6 shows pictures of various tractors able to accept a Windeck device.

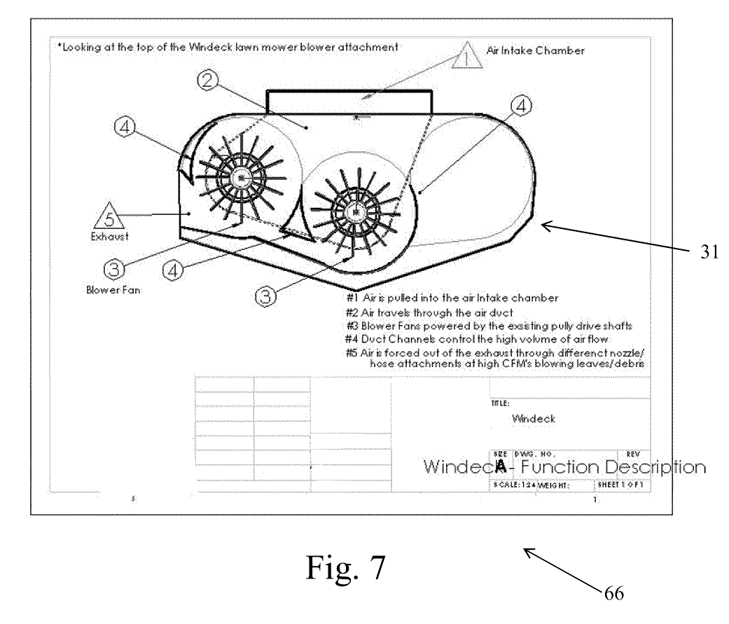

FIG. 7 shows the general specification and description of the Windeck device.

### DESCRIPTION OF THE DRAWINGS

### Reference Numerals

The following list refers to the drawings:

TABLE B
Reference numbers

| Ref # | Description |
|---|---|
| 31 | General Windeck Lawn Mower Blower Attachment Device |
| 31A | Top exterior face of general windeck |
| 32 | Bottom exterior face of lower air duct |
| 33 | Bottom exterior face of general windeck |
| 37 | Means to connect main body to pole adapter |
| 39 | Blower Fan(s) |
| 39A | Means for Mounting - aperture and key |
| 40 | Air Intake chamber |
| 40A | Aperture between air intake chamber and lower air duct |
| 41 | Lower Air Duct |
| 41A | Perimeter of Lower air duct |
| 42 | Upper Duct baffle plates |
| 43 | Upper Air Duct |
| 44 | Windeck perimeter |
| 50 | Exhaust |
| 63 | Means to removably attach windeck 31 under a mower deck |
| | at the perimeters 44, 64 |
| 64 | Mower deck perimeter |
| 65 | Various mowers with decks 64 |
| 66 | Description sheet for windeck |
| → | Air flow direction |

### DETAILED DESCRIPTION OF PREFERRED EMBODIMENT

This invention relates to an apparatus for creating a strong force of concentrated energy and more particularly, but not by way of limitation, an apparatus for creating a blowing force of air pressure in cooperation with an industrial, commercial or home care lawn mower. Particularly this new device is related to devices and methods to create and provide a strong force of air in a safe and efficient manner when used with a mower device or equal. This Windeck Lawn Mower Blower Attachment Device 31 is a new combination of existing materials configured with unique features that provide an effective, practical and economical way to provide a air blower device. The preferred and alternative embodiments are described below. The preferred embodiment of the Windeck Lawn Mower Blower Attachment Device 31 is comprised of a removable main deck with various features such as an inlet air chamber; one or more air ducts; a series of baffles to direct the air movement through the device; and an exhaust duct all of which, including the features, are made of durable materials, and as a preferred embodiment at least one blower fan; and means to secure the main deck and blowers to a mower device. An alternative embodiment anticipates at least one blower and a means to connect the blower(s) to the mower but without the main deck to direct the air flow and with relatively less force as the preferred with the main deck and features.

There is shown in FIG. 1 through FIG. 7 a complete detail and operative embodiment of the Windeck Lawn Mower Blower Attachment Device 31. In the drawings and illustrations, one notes well that the FIG. 1 through FIG. 5 detail the special configuration and FIGS. 1, 2, 4, and 7 show the operative use of this invention. FIG. 6 shows several mowers that the device 31 is used with as an accessory. The operation of the Windeck Lawn Mower Blower Attachment Device 31 is discussed below in the Operations section.

The advantages for the Windeck Lawn Mower Blower Attachment Device 31 are listed above in the introduction. Succinctly the benefits are the device:
Is much stronger and more powerful than traditional air blower devices.
Uses existing equipment (mowers) for base power and converts it to wind energy.
May be used with existing mowers.
Is quick to change-over from cutting or mulching to blowing.
May be manufactured in an inexpensive manner with existing processes and equipment.
May be both installed and removed quickly.
May be stored in a relatively small area.
Is adaptable to various sized mowers.
Can be sold and distributed retail, wholesale, or E-commerce internet sales from a website.
May have various outer configurations to adapt to different marketing themes.
May be used during all seasons
May be manufactured from various durable materials such as metal—steel, steel alloys, aluminum, etc. or composites—plastics, reinforced plastics, etc.

The preferred embodiment of the Windeck Lawn Mower Blower Attachment Device is comprised of a main deck with various features such as an inlet air chamber; one or more air ducts; a series of baffles to direct the air movement through the device; and an exhaust duct all of which, including the features, are made of durable materials, and as a preferred embodiment at least one blower fan; and means to secure the main deck and blowers under a mower device. An alternative embodiment anticipates at least one blower and a means to connect the blower(s) to the mower but without the main deck under the mower to direct the air flow with relatively less same force as the preferred with the main deck and features.

The accompanying drawings, which are incorporated in and constitute a part of this specification, illustrate a preferred embodiment of the Windeck Lawn Mower Blower Attachment Device 31. The drawings together with the summary description given above and a detailed description given below serve to explain the principles of the Windeck Lawn Mower Blower Attachment Device 31. It is understood, however, that the Device 31 is not limited to only the precise arrangements and instrumentalities shown.

FIG. 1 is the general view of the Windeck Lawn Mower Blower Attachment Device 31 with features and components identified. The preferred embodiment of the Windeck Lawn Mower Blower Attachment Device 31 is comprised of a removable main deck 31A with various features such as an inlet air chamber 40; one or more air ducts 41,43; a series of baffles 42 to direct the air movement through the device; and an exhaust duct 50. All of these features and the deck 31A are made of durable materials, and as a preferred embodiment at least one blower fan; and means to removably secure 37 the main deck 31 and blowers 39 underneath a mower device. An alternative embodiment anticipates at least one blower 39 and a means to removably connect 37 the blower(s) to the mower but without the main deck 31 under the mower to create the air flow without relatively less force as the preferred with the main deck and features. This removable securement means 37 anticipates a mechanical fastening means such as splines, barbs, cable ties, threaded bolts and nuts, or pins and keepers and the like. The durable material anticipated for the Windeck Lawn Mower Blower Attachment Device 31 is a metal (such as steel, steel alloy, aluminum or the like) or composite material, or the like. One skilled in material selection well appreciates the plethora of materials—both natural and man-made composites—that may fully support the scope and spirit of this invention. These stated materials are exemplary and not limiting in scope. The air flow arrows are discussed below with operations.

FIG. 2 is the Windeck housing without blower fans. The preferred embodiment of the Windeck Lawn Mower Blower Attachment Device 31 with the removable main deck 31A; an inlet air chamber 40; one or more air ducts 41,43; a series of baffles 42 to direct the air movement through the device; and an exhaust duct 50. At the exhaust duct 50 various hose adapters, deflector vanes and the like may be easily attached. One note the perimeter 44 of the device 31 is noted. Contiguous to this perimeter is the mower deck 64 of the mower 65 (not shown). There is a removable securement means 63 as discussed below to secure the device 31 under the mower 65 at their respective deck perimeters 44, 64. Once connected, the main deck creates the lowermost surface of the ducts. All of these features and the deck 31A are made of durable materials. The air flow arrows are discussed below with operations.

FIG. 3 is a Windeck Top View without blower fans. The main deck 31A with various features such as an inlet air chamber 40; the lower air duct 41 (shaded), the upper air duct 43; a series of baffles 42 to direct the air movement through the device; and an exhaust duct 50. All of these features and the deck 31A are made of durable materials, and as a preferred embodiment at least one blower fan; and means 63 to removably secure 37 the main deck 31 and blowers 39 to a mower device 64.

FIG. 4 is a Windeck with the general view of air ducts chamber from the underside. Here the intake chamber 40 brings air through the aperture 40A and into the lower air duct 41 contained by its underside surface 32. Also shown are the windeck perimeter 44, the baffles 42, and the exhaust duct 50. One also may see the under deck surface 33 of the windeck 31 device. The air flow arrows are discussed below with operations.

FIG. 5 is an isometric of a typical blower fan 39. There are a plethora of fans of various sizes and configurations. The scope of the applicants' invention anticipates various fans 39 that are able to create enough air pressure and force. The scope also anticipates connecting the fan 39 by a removable means such as a key and keyway 39A or an equivalent removable securement mean.

FIG. 6 shows pictures of Various tractors 65 able to accept a Windeck device 31. The device 31 is removably secured to the deck 64 of the tractor 65 by a means for removably securing 63.

FIG. 7 shows the general specification and description of the Windeck device. This is an operational sketch and is explained below.

All of the details mentioned here are exemplary and not limiting. Other components specific to describing a Windeck Lawn Mower Blower Attachment Device 31 may be added as a person having ordinary skill in the field of air blowers and mower accessorial apparatuses well appreciates.

### OPERATION OF THE PREFERRED EMBODIMENT

The preferred embodiment for the Windeck Lawn Mower Blower Attachment Device 31 has been described in the above paragraphs. The manner of how the device operates is described below. One skilled in the art of air blowers and mower accessorial apparatuses will note that the description above and the operation described here must be taken together to fully illustrate the concept of the Windeck Lawn Mower Blower Attachment Device 31.

The preferred embodiment of the Windeck Lawn Mower Blower Attachment Device is comprised of a main deck with various features such as an inlet air chamber; one or more air ducts; a series of baffles to direct the air movement through the device; and an exhaust duct all of which, including the features, are made of durable materials, and as a preferred embodiment at least one blower fan; and means to secure the main deck and blowers to a mower device. An alternative embodiment anticipates at least one blower and a means to connect the blower(s) under the mower but without the main deck to the air flow without the same force as the preferred with the main deck and features.

FIG. 1 is the general view of the Windeck Lawn Mower Blower Attachment Device 31 with features and components identified. The device is described above. Here the sequence shows that the ambient air (dashed arrow line →) is pulled into the air chamber 40; through the aperture 40A (not shown in this view); and into the lower air duct 41. The air is then pulled through one or more blower(s) 39 and discharged into the upper air duct 43 contained by the windeck surface 31A and the baffles 42. The air (solid arrow line →) from the pressure side of the fan(s) 39 then is forced through the upper air duct 43 and out the exhaust duct 50.

FIG. 2 is a Windeck housing without blower fans. The airflow is shown as just described but the fans 39 are not in the view.

FIG. 4 is a Windeck 31 with the general view of air ducts chamber underside. Once again the ambient air (dashed arrow line →) is pulled into the air chamber 40; through the aperture 40A (shown in this view); and into the lower air duct 41 (with the underside surface 32). The air is then pulled through one or more blower(s) 39 (not shown) and discharged into the upper air duct 43 contained by the windeck surface 31A/33 and the baffles 42. The air (solid arrow line →) from the pressure side of the fan(s) 39 then is forced through the upper air duct 43 and out the exhaust duct 50.

FIG. 7 shows the general specification 66 and description of the Windeck device 31. Note the different numbering of the features is readily understood by the reference numbers (Paragraph 24, above) and the FIG. 1.

With the above description it is important to understand the many uses possible for this device 31. As an example or illustration and not for limitation of the device, the Table C shows possible uses:

TABLE C
Various USES:

| ITEM | USE |
|---|---|
| 1. | Lawn Care - Grass management after mowing |
| 2. | Airports - blowing off runways |
| 3. | Stadiums - blowing off snow or other debris on turf, as |
| | well as connecting hoses and blowing off debris in |
| | stands |
| 4. | Roads - blowing off debris |
| 5. | Cleaning out gutters - with the proper hose attachment |
| 6. | Racetracks - blowing off debris and light snow |
| 7. | Parking Lots - blowing off debris and light snow |
| 8. | Construction zones - clean up debris and sites |
| 9. | Golf Courses - blowing off debris from fairways |
| 10. | Baseball, Football, Soccer, Softball, Polo, Rugby . . . |
| | etc Fields - Debris cleanup |
| 11. | Leaf Cleanup - pretty much anywhere . . . |
| 12. | Debris cleanup - pretty much anywhere . . . |
| 13. | Light snow removal - pretty much anywhere . . . |

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described in the above paragraphs. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With the above description it is to be understood that the Windeck Lawn Mower Blower Attachment Device 31 is not to be limited to only the disclosed embodiment. The features of the Windeck Lawn Mower Blower Attachment Device 31 are intended to cover various modifications and equivalent arrangements included within the spirit and scope of the description.

What is claimed is:

1. A Windeck Lawn Mower Blower Attachment Device made of durable material and comprised of
(a) a main deck with features;
(b) at least one blower fan; and
(c) a means to secure the main deck and blowers under a mower device
wherein the fans increase the air pressure of the mower and the exhaust results in a strong and powerful airflow than traditional air blower devices.

2. The device according to claim 1 wherein the durable material is a metal.

3. The device according to claim 2 wherein the metal is an aluminum alloy.

4. The device according to claim 2 wherein the metal is a steel alloy.

5. The device according to claim 1 wherein the durable, material is a composite material.

6. The device according to claim 1 wherein the means to secure is at least one fastener.

7. The device according to claim 6 wherein the fastener is threaded.

8. The device according to claim 1 wherein the means to secure is at least one spline.

9. The device according to claim 1 wherein the means to secure is at least one set of cotter pins and apertures.

10. The device according to claim 1 wherein the means to secure is a cable through apertures in the perimeter of the deck and mower.

11. The device according to claim 1 wherein the features in the main deck are comprised of:
a) an inlet air chamber;
b) at least one air duct;
c) a series of baffles to direct the air movement through the device; and
d) an exhaust duct with features.

12. A Windeck Lawn Mower Blower Attachment Device made of durable material and comprised of
(a) at least one blower fan; and
(b) a means to secure the main deck and blowers under a mower device.

13. A Windeck Lawn Mower Blower Attachment Device made of durable material and comprised of
(a) a main deck with various features such as
1) an inlet air chamber;
2) at least one air duct;
3) a series of baffles to direct the air movement through the device; and
4) an exhaust duct with features
(b) at least one blower fan; and
(c) a means to secure the main deck and blowers under a mower device
wherein the fans increase the air pressure of the mower and the exhaust results in a strong and powerful airflow than traditional air blower devices.
